(19) United States
(12) Patent Application Publication
(10) Pub. No.: US 2013/0001294 A1
(43) Pub. Date: Jan. 3, 2013

(54) STORAGE DEVICE WITH AN ICON AND ITS IDENTIFICATION SYSTEM

(75) Inventors: Hong-Chi Yu, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/267,014

(22) Filed: Oct. 6, 2011

(30) Foreign Application Priority Data
Jun. 29, 2011 (TW) 100122782

(51) Int. Cl. G06F 17/30; G06K 19/06

(52) U.S. Cl. 235/375; 235/494

(57) ABSTRACT

The present invention fulfills an icon on a storage device accessed by one user and the icon's saved content, e.g., digital data saved in the storage device, displayed or a specific program corresponding to the saved content executed; as a result, the digital data in the storage device is quickly and effectively accessed by one user without any electronic data exchange device required.

### BACKGROUND OF THE INVENTION

1) Field of the Invention

The present invention relates to a storage device, especially a storage device with an icon and its identification system.

2) Description of the Prior Art

With development or progress of information technologies, there are more and more digital data saved in all manner of storage devices, especially portable storage devices with Universal Serial Bus (USB) ports attracting the public's interests because of some advantages such as lightness, portability and plug-and-play. Prior to digital data in a portable USB storage device accessed by one user, the portable storage device's USB connector should be connected to a USB port on an electronic data exchange device, e.g., PC (with basic requirements such as host, output device, input device and storage device) for applications of the digital data which includes, without limitation, a web address linking a specific web site or a specific message accessed by a user via a PC's output device.

However, any digital data in a portable USB storage device cannot be accessed by one user who has an electronic data exchange device, e.g., PC, without any USB port or is within an environment without a computer available. Accordingly, it is necessary to find a solution which contributes to information fast acquired and real-time value remained in an environment of information fast communicated.

Additionally, it is advantageous for users to carry mobile communications devices available everywhere, cell phones especially, because of their compact appearances. With an open source OS embedded into cell phones becoming a mainstream, cell phones' functions have been developed to be diversified applications currently such as downloading icons (ringing tones or games), entertainment (replaying music or videos), snap shot, sound or icon recording, basic office applications (Internet, e-mails, text editing and storage of data), and Global Positioning System (GPS) from original real-time communication, pure dialing or answering. In this context, cell phones have almost become every person's necessity.

The appeal for compact design at a cell phone, however, results in neither installation of a USB port nor digital data in a portable USB storage device accessed by the cell phone. Thus, it is necessary to find a solution for this issue.

### SUMMARY OF THE INVENTION

To solve the said problems, the present invention provides a storage device with an icon displayed and its identification system which comprises an integrated circuit module, at least a carrier and at least an icon: (1) Carrier used to carry the integrated circuit module with metal contacts exposed outside; (2) Icon displayed on the carrier's at least one outer surface and exposed outside. Or, the storage device comprises an integrated circuit module and at least an icon which is installed on a package body's at least one surface and exposed outside. Additionally, the identification system comprises a mobile communications device and a storage device with an icon displayed. The icon accessed by the mobile communications device's image capture unit and decoded by a decoding unit will be shown on a display unit or activates one specific program according to saved content of the icon. Accordingly, the present invention provides a storage device comprising at least an icon and allows either the icon's content caught by a mobile communications device to be decoded and displayed or a specific program to be executed.

The major object of the present invention is to allow digital data saved in the storage device to be accessed and displayed with the icon's content caught by a user's communications device or a specific program to be executed, so that the user could quickly acquire digital data in the storage device without another electronic data exchange device required.

To this end, the present invention has the principal technical measures delivered with the following techniques. The present invention is a storage device with an icon displayed comprises an integrated circuit module with a substrate and at least an electronic component, at least a carrier and at least an icon: (1) Substrate with an inner surface and an outer surface which is equipped with a plurality of metal contacts; (2) Electronic component installed on the substrate's inner surface; (3) Carrier used to carry the integrated circuit module with its metal contacts exposed outside; (4) Icon installed on the carrier's at least one outer surface and exposed outside.

The purposes and the technical issues with respect to the present invention are further embodied with the following technical measures.

In the said storage device with an icon, the metal contacts are compatible to the Universal-Serial-Bus (USB) data transfer interface.

In the said storage device with an icon, the electronic component comprises at least a memory chip and a control chip.

In the said storage device with an icon, the integrated circuit module comprises a package body developed inside the substrate's inner surface and encasing the electronic components.

In the said storage device with an icon, the icon could be 1-dimentional (1D) barcodes or international standard 2-dimentional (2D) barcodes among Code16K, Supercode, Code49, QR code, PDF417, DataMatrix, Maxicode, Aztec, Vericode, Softstrip, Codel, CP, Codablock F, Ultracode, and Philips Dot Code.

In the said storage device with an icon, the icon comprises saved content such as web address, business card, personal account and identification code.

In the said storage device with an icon, the carrier could be manufactured with either at least one material among plastic, paper or metal or a combination of these materials thereof.

The present invention could be delivered with another technical measure. The storage device with an icon comprises an integrated circuit module and at least an icon wherein the integrated circuit module has a substrate with an inner surface and an outer surface provided with a plurality of metal contacts, at least an electronic component installed on the substrate's inner surface, and a package body developed on the substrate's inner surface and encasing the electronic components, and the icon is installed on the package body's at least one surface and exposed outside.

The identification system in the present invention of a storage device with an icon comprises a mobile communications device with an image capture unit, a decoding unit, a display unit and a storage device with an icon and has features as follows: With the icon caught by the mobile communications device's image capture unit and decoded by the decoding unit, the icon's saved content is indicated on the display unit or a specific program corresponding to the saved content is activated.

In contrast to prior arts, the present invention allows a user's mobile communications device to catch an icon installed on the storage device and display the icon's saved content, e.g., digital data saved in the storage device, so that the user could quickly acquire digital data in the storage device without another electronic data exchange device required.

### BRIEF DESCRIPTIONS OF THE DRAWINGS

FIG. 1 is the perspective view of the first embodiment for the present invention of a storage device with an icon and its identification system.

FIG. 2 is the cross-sectional view of the first embodiment for the present invention of a storage device with an icon and its identification system.

FIG. 3 is the block diagram of the first embodiment for the present invention of a storage device with an icon and its identification system.

FIG. 4 is the perspective view of the second embodiment for the present invention of a storage device with an icon and its identification system.

### DETAILED DESCRIPTIONS OF THE PREFERRED EMBODIMENTS

For objects, characteristics, and effects obviously and easily understood, the preferred embodiments of the present invention are particularly interpreted as follows:

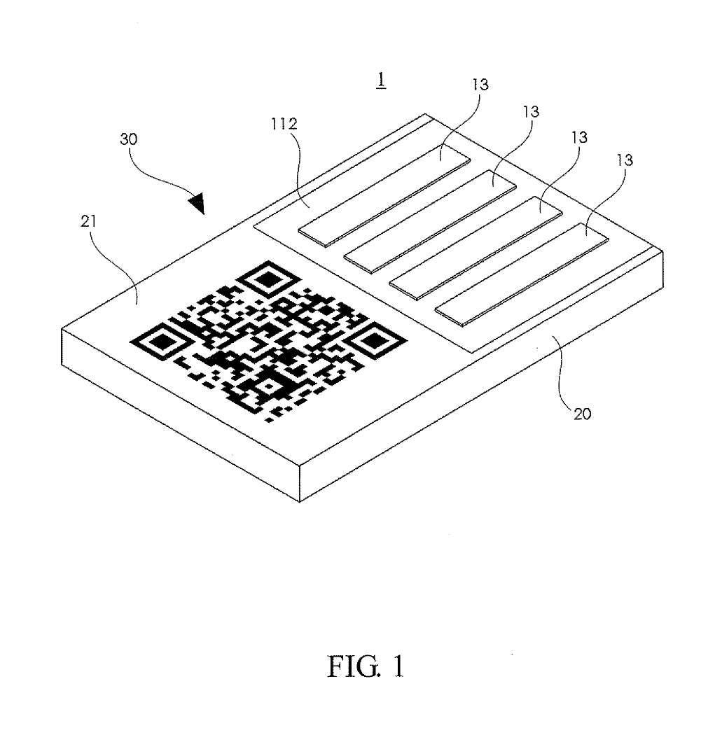

FIGS. 1˜3 are the first embodiment of the present invention of a storage device with an icon.

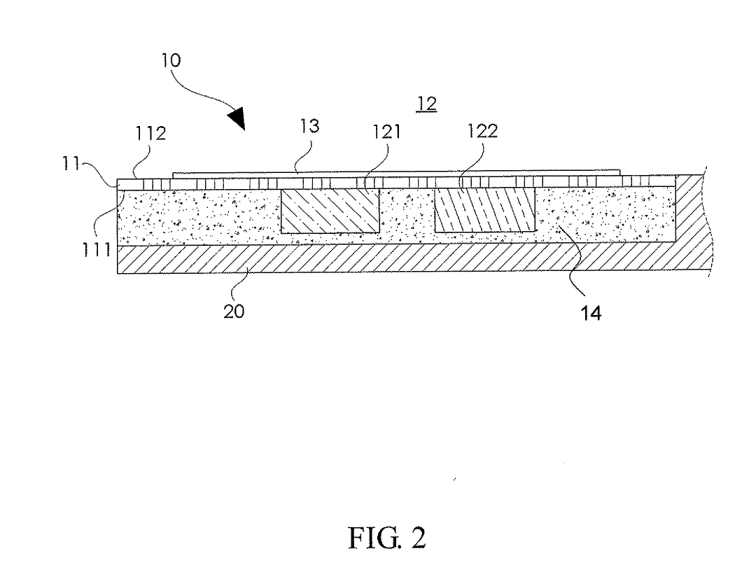

Referring to FIGS. 1 and 2 which illustrate the present invention's storage device with an icon (1) comprises an integrated circuit module (10), at least a carrier (20) and at least an icon (30): The integrated circuit module (10) as a Chip-On-Board (COB) package comprises a substrate (11) and at least an electronic component (12) wherein the substrate (11) has an inner surface (111) and an outer surface (112) equipped with a plurality of metal contacts (13) and the electronic component (12) is installed on the inner surface (111) of the substrate (11) and electrically connected to the substrate (11) by means of wire bonding or a flip chip technique (not shown in figures). Specifically, the substrate (11) is usually a high-density double-sided multi-layer printed circuit board with circuits (not shown in the figure) developed inside as an interface for transmit of electricity and allows the metal contacts (13) to be electrically connected to the electronic component (12) via the substrate (11).

In detail, the electronic component (12) comprises at least a memory chip (121) and a control chip (122). The memory chip (121) is used to provide writable/readable digital data, for instance, digital data saved in the memory chip (121) such as web address, business card, personal account, identification code, etc. in this embodiment. Furthermore, the control chip (122) used to control access of data is electrically connected between the memory chip (121) and metal contacts (13).

Preferably, the metal contacts (13) are compatible to at least one data transfer interface of USB 2.0 or 3.0 Series A male connector or a combination of these interfaces.

Preferably, the inner surface (111) of the substrate (11) of the integrated circuit module (10) is developed to be a package body (14) with the electronic component (12) encased.

In addition, passive elements (not shown in the figure) necessary to the integrated circuit module (10) are also installed on the inner surface (111) of the substrate (11) and encased within the package body (14).

Referring to FIGS. 1 and 2 which illustrates the carrier (20) is used to carry the integrated circuit module (10) and allows metal contacts (13) to be exposed outside. Normally, the metal contacts are electrically connected to one computer's port, e.g., a USB port (not shown in the figure); preferably, the carrier (20) could be manufactured with at least one material among plastic, paper and metal or a combination of these materials thereof.

The icon (30) is installed on at least one outer surface (21) of the carrier (20) and exposed outside wherein the icon (30) includes, without limitation, 1D barcodes and international standard 2D barcodes such as Code16K, Supercode, Code49, QR code, PDF417, DataMatrix, Maxicode, Aztec, Vericode, Softstrip, Code1, CP, Codablock F, Ultracode, and Philips Dot Code. In this embodiment, the icon is the QR code.

Preferably, the icon (30) has saved content such as web address, business card, personal account, identification cord, etc. which are identical to digital data saved in the memory chip.

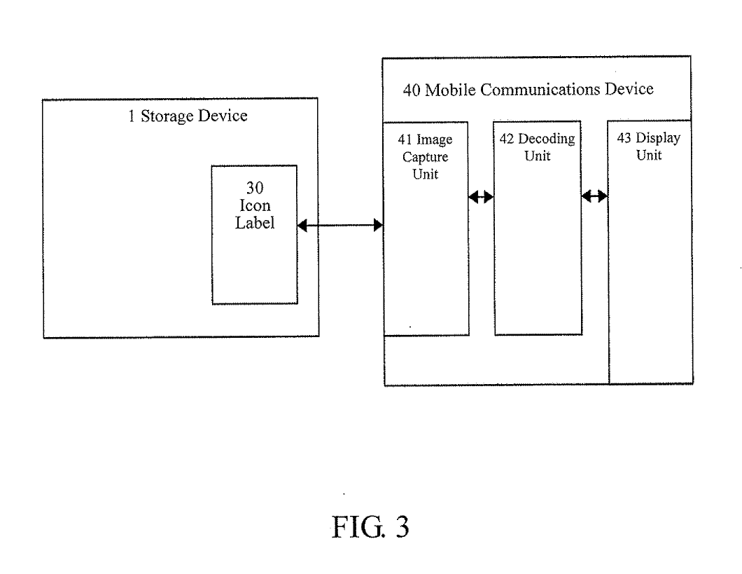

Referring to FIGS. 1-3 which illustrate the present invention of a storage device with an icon comprises a mobile communications device (40) and the said storage device with an icon (1) wherein the mobile communications device (40) could be a handheld communications device (mobile phone for example) comprising an image capture unit (41), a decoding unit (42) and a display unit (43). The mobile communications device (40) features the icon (30), which is received by an image capture unit (41) of the mobile communications device (40) and decoded with the decoding unit (42), is saved and indicated on a display unit (43), or a specific program corresponding to the saved content of the icon (30) is executed.

Preferably, the image capture unit (41) of the mobile communications device (40) could be an optic lens used to catch the icon (30); the display unit (43) could be a display panel device for indicating saved and decoded content; preferably, the decoding unit (42) as one tool used to decode and identify an icon could be an execution file/program of decoding software which is saved in the storage device (1) beforehand and installed in the mobile communications device (40) by one user. The technique to install the execution file/program thereof belongs to prior arts and not repeatedly described herein.

Accordingly, a user in an environment without a computer or any electronic data exchange device such as PC with USB ports could use the mobile communications device (40) to catch the icon (30) on at least one outer surface (21), so that the icon (30) is further decoded with the decoding unit (42) and a specific program based on the icon's saved content is activated or the saved content thereof is indicated on the display unit (43). In the case of the saved content including, without limitation, a web address, one user could depend on the web address to link a specific web site via the mobile communications device (40) or be aware of any particular messages saved in the content immediately.

With above descriptions summarized, the present invention allows a user to catch and display the save content of an icon, e.g., digital data saved in the storage device, via a mobile communications device, so that the user could quickly and effectively acquire digital data in the storage device without any electronic data exchange device required.

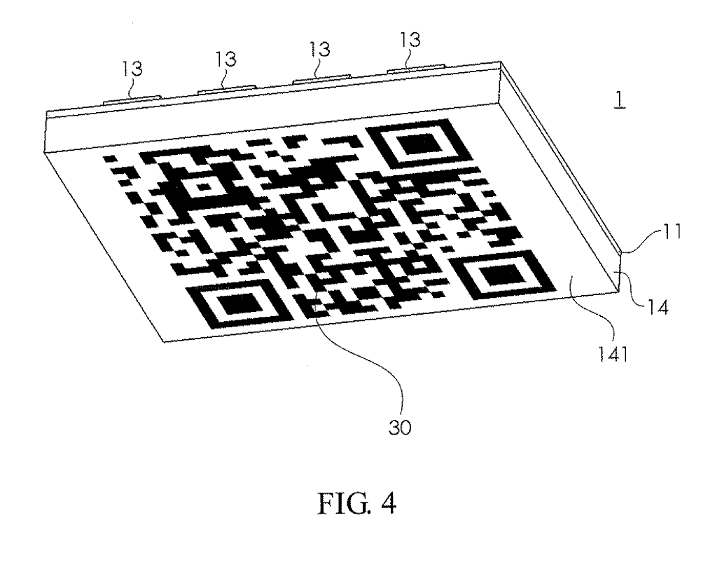

Referring to FIG. 4 which illustrates the second embodiment of the present invention wherein those structural characteristics described in the first embodiment and FIGS. 1˜3 are marked with the same symbols and not repeatedly interpreted.

The second embodiment different from the first one consists in no carrier included in the second embodiment and at least one icon (30) installed on at least one surface (141) of the package body (14) in order to expose the icon (30) outside. As a result, an icon received by the mobile communications device and decoded by the decoding unit allows saved content to be indicated on a display unit or a specific program, which is corresponding to the saved content, to be executed. Other technical features of the second embodiment are identical to those of the first one and not repeatedly interpreted.

As a preferred embodiment in the present invention, either the first embodiment or the second embodiment, however, is not used to restrict an icon's position installed on the invention, and any change or modification out of the said embodiments conducted by any person skilled in the art without departing from spirit of the present invention or the scope of disclosures and drawings is still within the technical scope protected by the present invention,

The present invention allows a user to catch and display saved content of an icon, e.g., digital data saved in the storage device, by means of a mobile communications device, so that the user could quickly and effectively acquire digital data in the storage device without any electronic data exchange device required.

As a result, the present invention featuring its effects different from general conventional storage devices and referred to as creative work among similar structures meets patentability and is applied for the patent.

It must be stressed that the said disclosures demonstrate the preferred embodiments of the present invention only and any equivalent change in disclosures, claims or drawings with respect to the present invention is still within the technical scope protected by the present invention which refers to claims hereinafter.

What is claimed is:

1. A storage device with an icon (1) comprises:
An integrated circuit module (10) comprising a substrate (11) and at least an electronic component (12) wherein the substrate (11) has an inner surface (111) and an outer surface (112) which is equipped with a plurality of metal contacts (13) and the electronic component (12) is installed on the inner surface (111) of the substrate (11);
At least a carrier (20) used to carry the integrated circuit module (10) with the metal contacts (13) exposed outside;
At least an icon (30) installed on at least an outer surface (21) of the carrier (20) and exposed outside.

2. The storage device with an icon (1) according claim 1 wherein the metal contacts (13) are compatible to the Universal-Serial-Bus (USB) data transfer interface.

3. The storage device with an icon (1) according claim 1 wherein the electronic component (12) comprises at least a memory chip (121) and a control chip (122).

4. The storage device with an icon (1) according claim 1 wherein the integrated circuit module (10) comprises a package body (14) which is developed on the inner surface (111) of the substrate (11) and encases the electronic components (12).

5. The storage device with an icon (1) according claim 1 wherein the icon (30) could be 1D barcodes or international standard 2D barcodes among Code16K, Supercode, Code49, QR code, PDF417, DataMatrix, Maxicode, Aztec, Vericode, Softstrip, Code1, CP, Codablock F, Ultracode, and Philips Dot Cod.

6. The storage device with an icon (1) according claim 1 wherein the icon (30) has saved content comprising information such as web address, business card, personal account and identification code.

7. The storage device with an icon (1) according claim 1 wherein the carrier (20) is manufactured with at least one material among plastic, paper or metal or a combination of these materials thereof.

8. The storage device with an icon (1) comprises:
An integrated circuit module (10) comprising a substrate (11), at least an electronic component (12) and a package body (14) wherein the substrate (11) has an inner surface (111) and an outer surface (112), which is equipped with a plurality of metal contacts (13), the electronic component (12) is installed on the inner surface (111) of the substrate (11), and the package body (14) is developed on the inner surface (111) of the substrate (11) and encases the electronic components (12);
At least an icon (30) installed on at least a surface (141) of the package body (14) and exposed outside.

9. An identification system of the storage device with an icon comprises:
A mobile communications device (40) comprising an image capture unit (41), a decoding unit (42), a display unit (43) and the storage device with an icon (1) according to claim 1;
Characteristics:
With the icon (30) received by the image capture unit (41) of the mobile communications device (40) and decoded with the decoding unit (42), the saved content of the icon (30) is displayed on the display unit (43) or a specific program corresponding to the saved content of the icon (30) is activated.

10. The identification system of the storage device with an icon according to claim 9 wherein the image capture unit (41) could be an optical lens used to catch the icon (30).

11. The identification system of the storage device with an icon according to claim 9 wherein the display unit (43) could be a display panel device used to indicate content of the icon decoded.

12. An identification system of the storage device with an icon comprises:
A mobile communications device (40) comprising an image capture unit (41), a decoding unit (42), a display unit (43) and the storage device with an icon (1) according to claim 8;
Characteristics:
With the icon (30) received by the image capture unit (41) of the mobile communications device (40) and decoded with the decoding unit (42), the saved content of the icon (30) is displayed on the display unit (43) or a specific program corresponding to the saved content of the icon (30) is activated.

13. The identification system of the storage device with an icon according to claim 12 wherein the image capture unit (41) could be an optical lens used to catch the icon (30).

14. The identification system of the storage device with an icon according to claim 12 wherein the display unit (43) could be a display panel device used to indicate content of the icon decoded.
